(19) United States
(12) Patent Application Publication
(10) Pub. No.: US 2012/0050818 A1
(43) Pub. Date: Mar. 1, 2012

(54) SENDING SCANNED DOCUMENT DATA THROUGH A NETWORK TO A MOBILE DEVICE

(76) Inventor: Kaoru Watanabe, Sunnyvale, CA (US)

(21) Appl. No.: 12/873,116

(22) Filed: Aug. 31, 2010

(51) Int. Cl. H04N 1/00

(52) U.S. Cl. 358/407

(57) ABSTRACT

An approach for processing scanned document data includes a document processing network service receiving, from a scanning device, scanned document data that represents text contained in one or more printed documents. The document processing network service, sends, based on mobile device data received from the scanning device, the scanned document data (or text data generated from the scanned document data) to one or more mobile devices identified in the mobile device data. An approach for processing scanned document data also includes a document processing network service, in response to receiving scanned document data and recipient data from a scanning device, extracting contact information from the scanned document data and causing the contact information to be stored in association from the recipient data to allow a mobile device of an intended recipient to receive the contact information and initiate a call to a phone number identified in the contact information.

### FIELD OF THE INVENTION

This invention relates generally to scanning technology, and more specifically, to an approach for processing scanned document data.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Many individuals and business organizations are scanning an increased number of printed documents. Maintaining documents in electronic form requires less space and allows documents to be accessed by multiple users, without having to make additional printed copies. One of the issues with scanning documents is the difficulty of distributing the scanned document data to intended recipients. Distribution of scanned document data may be performed at a scanning device where the printed document is first scanned. Some scanning devices allow a user to specify a destination for the scanned document data, for example by selecting a location or recipient from an address book or contact list. The scanning device then transmits the scanned document data to the selected location or recipient.

Distribution of scanned document data may also be performed from another location. For example, a user may scan a printed document and select their name as the recipient. The scanning device transmits the scanned document data to the user, for example, by sending the scanned document data as an email attachment to the user's personal computer. The user then uses their email client to forward the scanned document data to one or more other recipients. Both of these approaches require multiple steps and can be cumbersome when contact information for the intended recipient is not already stored in either the scanning device or the user's email client, because the user has to manually enter the recipient's contact information, for example by typing an email address of the recipient. Based on the foregoing, there is a need for an approach for better processing scanned document data.

### SUMMARY

An approach is provided for processing scanned document data. A document processing network service executes on a network device and receives, from a scanning device over a network using an IP protocol, scanned document data that represents one or more printed documents. The document processing network service sends particular document data to a mobile device based on mobile device data received from the scanning device. The particular document data is the scanned document data or is document data that is generated from the scanned document data. The mobile device data includes an identifier of a mobile device of an intended recipient of the scanned document data. The mobile device data may be separate from the scanned document data or may be data within the scanned document data.

A related approach is provided for processing scanned contact data. A document processing network service executes on a network device and receives, from a scanning device over a network using an IP protocol, (a) scanned contact data that represents one or more printed documents that include contact data and (b) recipient data that includes an identifier of an intended recipient of contact data within the scanned contact data. In response to the document processing network service receiving the scanned contact data, a network service generates text data that represents text contained in the one or more printed documents, a network service processes the text data to identify, in the text data, phone data for an intended recipient, and a network service sends, based on the recipient data, the phone data to a contact manager network service associated with the recipient. The recipient, using his/her client device, retrieves the phone data and is able to initiate a call with a mobile device identified by a phone number indicated in the phone data.

### BRIEF DESCRIPTION OF THE DRAWINGS

In the figures of the accompanying drawings like reference numerals refer to similar elements.

FIG. 1 is a block diagram that depicts an example architecture for processing scanned document data.

FIG. 2 depicts an example operation panel of a scanning device.

FIG. 3 is a flow diagram that depicts an approach for sending scanned document data to one or more mobile devices.

FIG. 4 is a flow diagram that depicts an approach for sending scanned contact data to one or more devices.

FIG. 5 is a message ladder diagram that depicts an example message exchange between the elements of FIG. 1 during the processing of scanned document data as described herein.

FIG. 6 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. SCANNED DOCUMENT DATA PROCESSING ARCHITECTURE
A. SCANNING DEVICE
B. CLOUD
C. CLIENTS
D. OPERATION PANEL
   1. SCAN-TO-MOBILE GUI OBJECT
   2. SCAN-TO-CONTACTS GUI OBJECT

III. PROCESSING SCANNED DOCUMENT DATA
A. SCAN-TO-MOBILE
B. SCAN-TO-CONTACTS

V. IMPLEMENTATION MECHANISMS

### I. Overview

An approach is provided for processing scanned document data. A document processing network service receives, from a scanning device over a network, (a) scanned document data that represents one or more printed documents and (b) mobile device data that identifies a mobile device of an intended recipient of the scanned document data. The document processing network service sends, based on the mobile device data, the scanned document data to the mobile device of the intended recipient. The document processing network service may use Multimedia Messaging Service (MMS) to send to the scanned document data to the mobile device.

A related approach is for a document processing service to receive, from a scanning device over a network, scanned document data and recipient data. The document processing network service analyzes the scanned document data to identify a phone number. Upon detection of such a phone number in the scanned document data, the document processing network service stores the phone number in association with account(s) of recipient(s) identified in the recipient data. The phone number is later provided to a device of a recipient user. The phone number is selectable by the user, which causes the recipient's device to initiate a call with the mobile device identified by the phone number.

### II. Scanned Document Data Processing Architecture

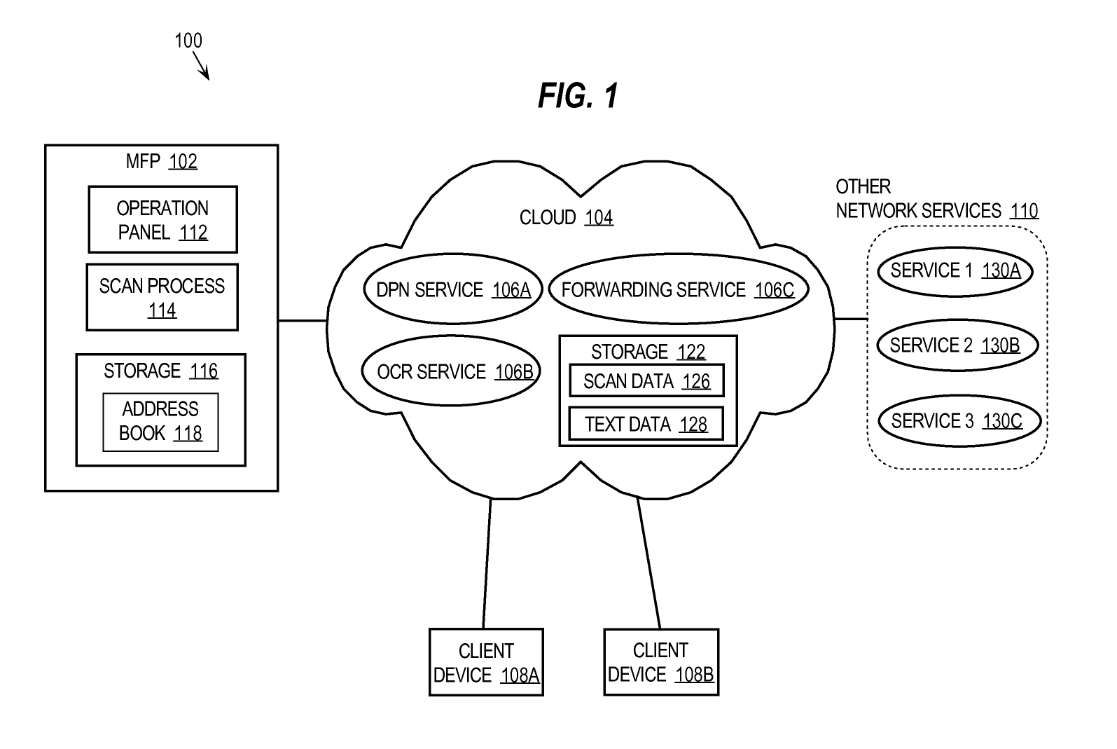

FIG. 1 is a block diagram that depicts an example architecture for processing scanned document data. Architecture 100 includes a scanning device 102, a cloud 104, client devices 108A, 108B, and other network services 110 that are each communicatively coupled to cloud 104. For illustration purposes only, other network services 110 includes services 130A-C. However, embodiments of the invention are not limited to these three network services. There may be any number (including zero) of other network services 110 that are communicatively coupled to cloud 104. The links between cloud 104 and each of scanning device 102, client devices 108A, 108B, and other network services 110 may be implemented by any medium or mechanism that provides for the exchange of data between the elements of FIG. 1. Examples of such links include, without limitation, a network such as a Local Area Network (LAN), Wide Area Network (WAN), Ethernet or the Internet, or one or more terrestrial, satellite or wireless links.

A. Scanning Device

Scanning device 102 is a device that includes the capability to scan one or more printed documents and generate scanned document data that represents the one or more printed documents. The scanned document data may be in a variety of formats, depending upon a particular implementation. One example format is the portable document format (PDF) by Adobe Systems, Inc. Scanning device 102 may also include a capability to convert scanned document data from a non-text format, such as PDF, to a text-based format, using for example, optical character recognition (OCR). Scanning device 102 may also include the capability to transmit the scanned document data to another location or device, for example, to a computer connected to the scanning device 102 or over a network to a network device. Examples of scanning device 102 include, without limitation, a scanner and a multi-function peripheral that includes one or more functions in addition to scanning, such as printing, copying, faxing, etc.

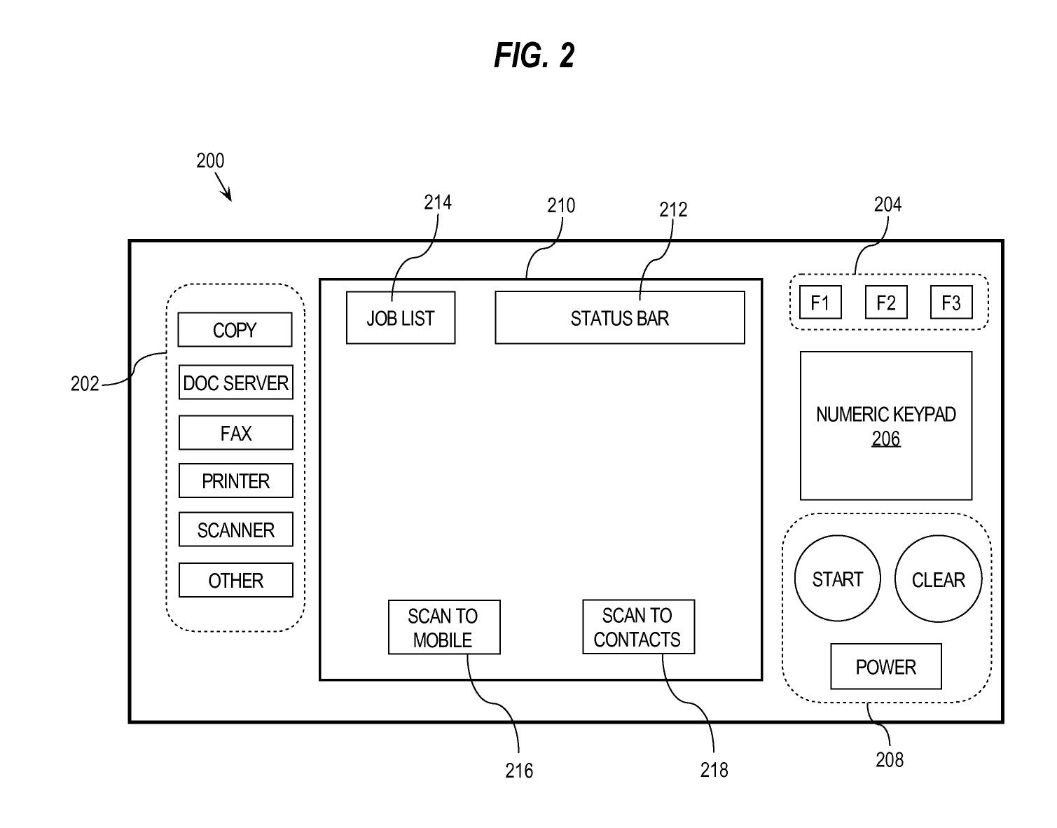

Scanning device 102 includes an operation panel 112, a scan process 114 and storage 116. The operation panel 112 is configured to display information to a user and to accept user input. The particular implementation of the operation panel 112 may vary depending upon a particular implementation. For example, the operation panel 112 may include a screen on which a graphical user interface (GUI) is displayed. In addition, the screen may be a touch screen that allows a user to select icons and GUI objects on the GUI. The GUI may be updated to reflect changes in the functionality offered by the scanning device 102. The operation panel 112 may also include control buttons and a numeric keypad for receiving user input. Operation panel 112 is described in more detail below with reference to FIG. 2.

Scan process 114 is configured to cause one or more printed documents to be scanned by scanning device 102 and generate scanned document data that represents the one or more printed documents. Scan process 114 may be initiated, for example, in response to a user selection of the start user control 208 or user selection of scan-to-mobile GUI object 216.

Storage 116 may be any combination of volatile or non-volatile storage for storing data used by scanning device 102. For example, the storage 116 may be random access memory (RAM), one or more disks, or any combination of RAM and one or more disks for storing scanned document data. As depicted in FIG. 1, storage 116 may store an address book 118 or contact data that is used by scanning device 102, for example, to obtain destination addresses for transmitting scanned document data. Scanning device 102 may include other modules and processes that are not depicted in FIG. 1 for purposes of brevity.

B. Cloud

A “cloud” is a computing system providing access via the Internet to processing power, storage, software or other computing services, often via a web browser. Thus, cloud 104 is viewed as a collection of services from the perspective of scanning device 102 and client devices 108A and 108B. At the hardware level (although transparent to scanning device 102 and client devices 108A and 108B), cloud 104 comprises one or more network devices that host the plurality of services.

Each of the services in a cloud is accessible via the Internet using an IP protocol. Thus, each service in (or hosted by) a cloud may be associated with a different IP address and/or port number.

A cloud may be maintained by a single individual or organization (e.g., company). However, multiple organizations may share responsibility in maintaining a particular cloud. A network service “outside” of a particular cloud (e.g., one of other network services 110) is provided by one or more individuals or organizations that are different than any individual or organization that maintains the particular cloud.

In FIG. 1, cloud 104 includes a document processing network (DPN) service 106A. DPN service 106A processes scanned document data as described in more detail hereinafter.

Cloud 104 may also include an OCR service 106B for converting scanned document data in non-text format, for example PDF, into text-based format. Cloud 104 may also include a forwarding service 106C for transmitting scanned document data in text format to one or more recipients. OCR service 106B and forwarding service 106C are depicted in FIG. 1 as being separate from DPN service 106A for purposes of explanation, but OCR service 106B and forwarding service 106C may be implemented as being part of DPN service 106A.

Storage 122 may be implemented as any type of volatile or non-volatile storage for storing data used by DPN service 106A. For example, storage 122 may be random access memory (RAM), one or more disks, or any combination of RAM and one or more disks for storing scanned document data. Storage 122 may store scanned document data 126 received by and/or processed by DPN service 106A, text data 128 generated by OCR service 106B, and/or contact data (not shown) extracted by DPN service 106A from the text data generated by OCR service 106B.

C. Clients

Client devices 108A, 108B receive scanned document data and/or text data from DPN service 106A, as described in more detail hereinafter. Client devices 108A, 108B may be implemented as any type of client device. Examples of client devices 108A, 108B include, without limitation, personal or laptop computers, workstations, cellular telephony devices such as cell phones, personal digital assistants (PDAs), etc.

D. Operation Panel

FIG. 2 depicts an example operation panel 200 of the scanning device 102. Operation panel 200 includes a set of user interface controls 202 for activating functions of the scanning device 102. The functions depicted in FIG. 2 includes copy, connect to a document server, fax, print, copy and other functions. These functions are provided as examples of typical functions that may be implemented on a scanning device that is an MFP, but the functions implemented on any particular scanning device may vary depending upon the implementation. Operation panel 200 also includes a set of function buttons 204 that may be assigned to various functions provided on scanning device 102. Operation panel 200 also includes a numeric keypad 206 and a set of user controls 208 for toggling the power, starting a function and clearing the current function. These are examples of the user controls that are typically included on a scanning device. More or fewer user controls may be provided, depending upon a particular implementation.

Operation panel 200 also includes a GUI 210 for displaying information and receiving user input. GUI 210 may be a touch screen that is capable of detecting user selection of icons and GUI objects displayed on GUI 210. GUI 210 may be stored on scanning device 102 and loaded directly from local storage of scanning device 102 (e.g., storage 116).

Alternatively, GUI 210 is provided by DPN service 106A or another service in cloud 104. A browser (not shown) executing on scanning device 102 may request GUI 210 from a service in cloud 104. The browser may send a HTTP request in response to selection of the scanning function on the set of UI controls 202 or upon startup of scanning device 102. In this way, GUI 210 may be updated remotely at any time before GUI 210 is loaded onto scanning device 102. Also, by relying on a service of cloud 104 for GUI 210, scanning device 102 is removed from the responsibility for persistently storing, updating, or otherwise maintaining GUI 210.

In the present example, GUI 210 includes a status bar GUI object 212 that displays status information, such as the status of the scanning device 102 or the status of one or more scan jobs. GUI 210 also includes a job list GUI object 214 which, when selected, displays a list of jobs associated with the scanning device 102, for example, scan jobs that have been processed and/or scan jobs that are currently being processed.

GUI 210 may include any number of other GUI objects depending upon a particular implementation, and the GUI objects depicted in FIG. 2 are provided as non-limiting examples.

1. Scan-to-Mobile GUI Object

In an embodiment, GUI 210 includes a scan-to-mobile GUI object 216. User selection of scan-to-mobile GUI object 216 causes scanning device 102 to send the scanned document data to one or more mobile devices (e.g., client devices 108A, 108B) via cloud 104, as described in more detail hereinafter. User selection of scan-to-mobile GUI object 216 may initiate the scanning of one or more printed documents to generate scanned document data. Alternatively, one or more printed documents may be scanned prior to user selection of GUI object 216. Thus, in this scenario, user selection of GUI object 216 does not initiate the scanning of the one or more printed documents. Instead, user selection of GUI object 216 causes the already-scanned document data to be sent to one or more mobile devices via cloud 104.

GUI 210 may include one or more GUI objects (not shown) and/or other user controls (not shown) that allow a user to identify one or more phone numbers. As part of the scan-to-mobile operation, scanning device 102 sends the one or more phone numbers to cloud 104 along with scanned document data in order for one or more services in cloud 104 to send the scanned document data (or other data generated therefrom) to mobile device(s) identified by the phone number(s).

A user may identify the one or more phone numbers in at least two ways. For example, the user may enter the one or more phone numbers into GUI 210 using numeric keypad 206. The phone number(s) may be stored locally or remotely for later retrieval and display by scanning device 102 so that the user is not required to enter in the phone number(s) again.

Additionally or alternatively, the one or more GUI objects that allow a user to identify one or more phone numbers may allow a user to select the one or more phone numbers from a list, i.e., without requiring the user to physically enter the phone numbers into scanning device 102. The list of phone numbers may be stored locally (i.e., on scanning device 102) or remotely by a service in cloud 104. One or more of the phone numbers in the list may have been submitted by a client device (e.g., client device 108A or 108B) to a contact service (or DPN service 106A) in cloud 104. The list of phone numbers may be loaded from cloud 104 onto scanning device 102 when GUI 210 is requested from cloud 104 or when scan-to-mobile GUI object 216 is selected.

Whether stored locally or remotely, the list of phone numbers may be stored in association with the user. For example, a user may be associated with a unique identifier. In response to the user logging into scanning device 102 and selecting scan-to-mobile GUI object 216, scanning device 102 uses the user's unique identifier to identify the list of phone numbers associated with the unique identifier. Alternatively, DPN service 106A (or another service in cloud 104) uses the user's unique identifier (received from scanning device 102) to identify the list of phone numbers associated with the unique identifier.

Additionally or alternatively to GUI 210 including one or more GUI objects that allow a user of scanning device 102 to identify one or more phone numbers, DPN service 106A (or another service in cloud 104), identifies one or more phone numbers in the scanned document data (or, e.g., in text data 128). Thus, for example, a user may include a business card (or another document with a phone number) along with the one or more printed documents in the scan process. In this way, a user is not required to identify any of the phone numbers.

2. Scan-to-Contacts GUI Object

In an embodiment, GUI 210 includes a scan-to-contacts GUI object 218. User selection of scan-to-contacts GUI object 218 causes scanning device 102 to send the scanned contact data to one or more mobile devices (e.g., client devices 108A, 108B) via cloud 104 or to a contact service in cloud 104, as described in more detail hereinafter. User selection of scan-to-contacts GUI object 218 may initiate the scanning of one or more printed documents (such as business cards) to generate scanned contact data. Alternatively, one or more printed documents may be scanned prior to user selection of GUI object 218. Thus, in this scenario, user selection of GUI object 218 does not initiate the scanning of the printed document(s). Instead, user selection of GUI object 218 causes the already-scanned document data to be sent to cloud 104.

User selection of scan-to-contacts GUI object 218 may cause a list of one or more user accounts to be displayed on GUI 210. Each user account may be associated with a username and password (or other authorization data, such as a unique token) to authorize the addition of the contact information to the user account. The list of one or more user accounts may be user accounts only of the user that selected the scan-to-contacts GUI object 218. Alternatively, the list of one or more user accounts may include a user account of a user other than the user that selected the scan-to-contacts GUI object 218.

The list of user accounts may be accounts previously registered by a user using one or more GUI objects (not shown) on GUI 210 and/or using user controls (not shown) of scanning device 102. Additionally or alternatively, the list of user accounts may be submitted by a client device (e.g., client device 108A or 108B) to a contact manager service (or DPN service 106A) in cloud 104. The list of user accounts may be loaded from cloud 104 onto scanning device 102 when GUI 210 is requested from cloud 104 or when scan-to-contacts GUI object 218 is selected. A user may select, in the list, one or more of the user accounts to which the scanned contact data (or data generated therefrom) will be sent.

### III. Processing Scanned Document Data

A. Scan-to-Mobile

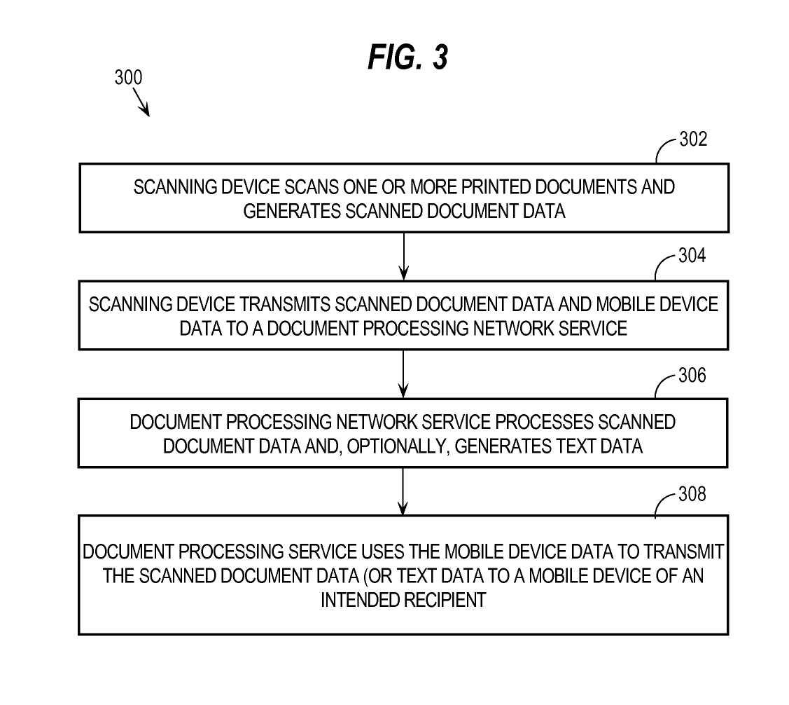

FIG. 3 is a flow diagram 300 that depicts an approach for processing scanned document data, according to one embodiment of the invention. In step 302, a scanning device scans one or more printed documents and generates scanned document data. For example, a user may place into a feeder of scanning device 102 one or more printed documents and select the scan user interface control 202 or scan-to-mobile GUI object 216 to initiate scanning.

In step 304, the scanning device transmits the scanned document data and mobile device data to a document processing network service in cloud 104. For example, scanning device 102 may transmit the scanned document data and mobile device data to a particular IP address that is associated with cloud 104 and that corresponds to DPN service 106A.

In step 306, the document processing network service processes the scanned document data and, optionally, generates text data. For example, DPN service 106A may use OCR service 106B to process the received scanned document data and generate text data 128 that may be stored temporarily or persistently on storage 122.

In step 308, the document processing network service uses the mobile device data to send the scanned document data (or, e.g., text data 128) to one or more mobile devices. Alternatively, the document processing service may use a messaging service (not shown) in cloud 104 to send the scanned document data to the one or more mobile devices. For example, DPN service 106A identifies one or more mobile devices identified in the mobile device data. The one or more mobile devices may comprise client devices 108A, 108B or other devices (not shown). DPN service 106A communicates the scanned document data (or a processed version thereof) and the phone number(s) identified in the mobile device data to a messaging service (not shown) in cloud 104. The messaging service uses the phone number(s) to send the scanned document data to the mobile device(s).

In an embodiment, the messaging service (or DPN service 106A) may use Multimedia Messaging Service (MMS) to send the scanned document data to the mobile device(s). MMS is a standard way (developed by the Open Mobile Alliance or OMA) to send messages that include multimedia content to and from mobile devices. MMS extends the core SMS (Short Message Service) capability which only allowed exchange of text messages up to 160 characters in length. One use of MMS has been to send photographs from camera-equipped handsets. In embodiments of the invention, however, MMS is used to send scanned document data to mobile devices.

A MMS message that is sent from the messaging service (whether as part of DPN service 106A or separate therefrom) to a mobile device may comprise, for example, simple text and a PDF document that represents the one or more scanned printed documents. In a related embodiment, a user-generated message (e.g., in the form of text) may be sent in conjunction with the scanned document data. The user-generated message may be entered, e.g., via GUI 210, to enable the user to send a message or instructions to the intended recipient(s) along with the scanned document data.

An optional step includes the document processing network service generating and transmitting a confirmation that indicates that the sending of the scanned document data to the intended recipient(s) has been completed. For example, DPN service 106A may generate and transmit a confirmation indicating that the scanned document data and/or text data 128 was transmitted to a particular recipient. The confirmation may be sent to, for example, the user that performed the scan at scanning device 102. In this situation, scanning device 102 may include in (or in conjunction with) the scanned document data, data that identifies scanning device 102 and/or the user who requested the scan of the one or more printed documents. DPN service 106A may be configured to locate in the text data 128 specified text or symbols that identify where the confirmation is to be sent. For example, scan process 114 may be configured to add to the scanned document data a text string “Send Confirmation To: XXX” when the scan-to-mobile GUI object 216 is selected, where XXX is an email address that corresponds to the user who initiated the scan-to-mobile operation. DPN service 106A is configured to search the text data 128 for the text string “Send Confirmation To:” and extract and use the address contained in XXX for the confirmation. The confirmation may also be sent to one or more recipients, depending upon a particular implementation. For example, instead of or in addition to sending a confirmation to an email address included in the scanned document data, DPN service 106A may be configured to send the confirmation to a specified address, for example of a particular user or administrator.

Another optional step includes the document processing network service storing the scanned document data and/or the text data for later retrieval. For example, DPN service 106A may store in storage 122 scanned document data received by and/or processed by DPN service 106A. DPN service 106A may also store the text data 128 in storage 122 for later retrieval. The scanned document data and the text data 128 may be retrieved, for example by a user via scanning device 102 or a user or administrator via client device 108A or 108B.

The approach described herein for processing scanned document data provides a very beneficial workflow for users. The approach allows a user to quickly and easily cause one or more printed documents to be scanned and cause the scanned document data to be sent to one or more mobile devices, all with one or a few selections of one or more objects on a GUI of a scanning device.

B. Scan to Contacts

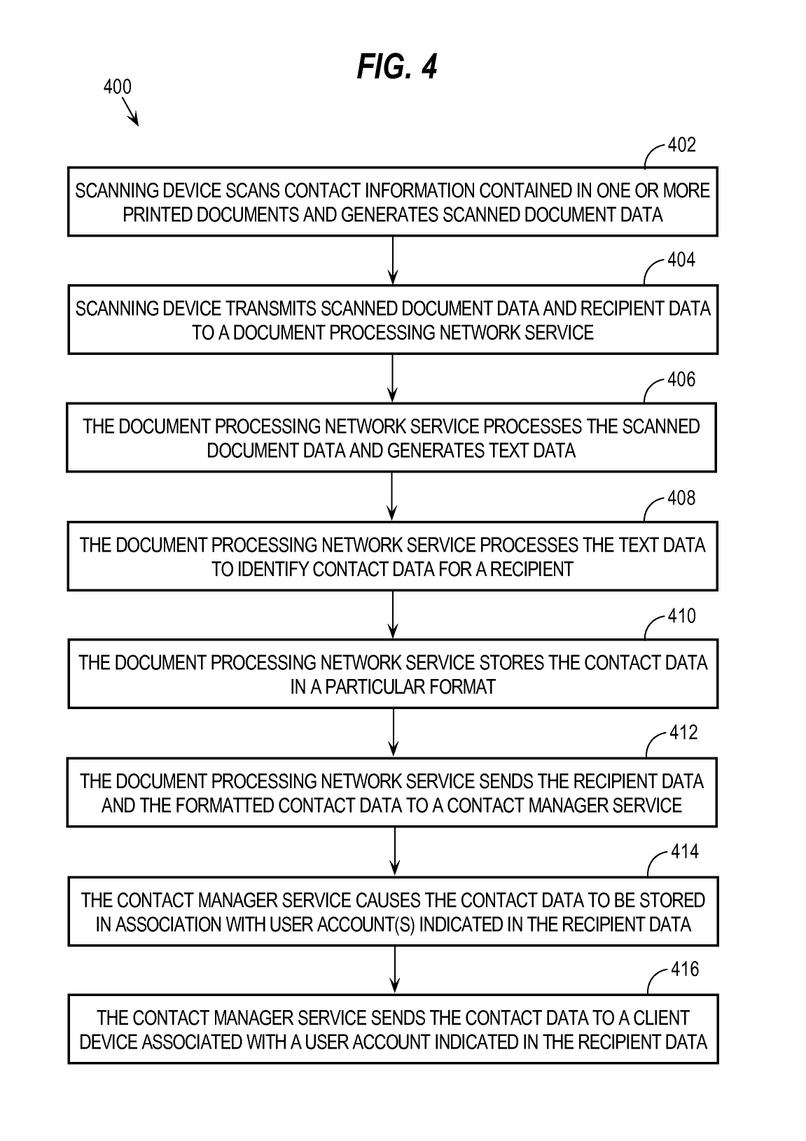

FIG. 4 is a flow diagram that depicts an approach for sending scanned contact data to one or more mobile devices, according to one embodiment of the invention. In step 402, a scanning device scans contact information contained on one or more printed documents and generates scanned contact data. For example, a user may place on the glass of scanning device 102 one or more business cards and select the scan user interface control 202 (or scan-to-contacts GUI object 218) to initiate scanning.

In step 404, the scanning device transmits the scanned contact data, along with recipient data (e.g., user account data), to a document processing network service. For example, scanning device 102 may transmit the scanned contact data to a particular IP address that is associated with cloud 104 and that corresponds to DPN service 106A.

In step 406, the document processing network service processes the scanned contact data and, optionally, generates text data. For example, DPN service 106A may use OCR service 106B to process the received scanned contact data and generate text data 128 that may be stored temporarily or persistently on storage 122.

In step 408, the document processing network service processes text data 128 to identify contact data for a recipient. For example, the DPN service 106A (or another network service) may identify a phone number for a recipient contained in text data 128. This may include searching text data 128 for text strings and/or symbols that correspond to a phone number, for example “YYY-YYY-YYYY,” where Y is a numeric character. According to a related embodiment of the invention, searching for contact information may include searching for a business card template contained in text data 128, i.e., data that is normally included together on a business card. For example, DPN service 106A may search for a grouping of text strings that correspond to an organization name, a contact name, an email address that corresponds to the contact name, and a telephone and/or facsimile number. When such a grouping is identified, indicating the presence of business card information, the contact information, e.g., phone number, name, email address, business address, and/or is extracted. In some situations, a user may place multiple business cards on scanning device 102 to be scanned in a single scan process. Thus, the document processing network service (or another network service) may identify each individual business card and process each business card individually.

In step 410, the document processing network service (or another service in cloud 104) stores the identified contact data in a particular format. For example, DPN service 106A stores the identified contact data in a CSV (or comma-separated values) format. There are numerous formats in which the identified contact data may be stored and embodiments of the invention are not limited to any particular format.

In step 412, the document processing network service sends the recipient data (transmitted from scanning device 102 in step 404) and the formatted contact data (generated in step 410) to a contact manager network service. For example, DPN service 106A sends the recipient data and the contact data identified in the scanned business card(s) to a contact manager service (not shown) that manages numerous user accounts. The contact manager network service may be a service in cloud 104 or may be one of the other network services 110 (i.e., “outside” cloud 104). A non-limiting example of a contact manager network service or other service that can store contact data and that is one of the other network services 110 include Box.net™, Google Sync™, LinkIn™, Jigsaw™, Salesforce.com™, Quickbook Online™, and Gmail Contacts™.

In step 414, the contact manager network service causes the formatted contact data to be stored in association with each user account indicated in the recipient data. Thus, if there are three user accounts, then the contact manager network service causes the identified contact data to be stored in association with each of the three user accounts.

In step 416, the contact manager network service sends the formatted contact data to the client device associated with the user account indicated in the user account data. The contact manager network service may send the identified contact data to a client device in response to receiving a request from the client device (e.g., client device 108A or 108B) to receive new or updated contact information from the contact manager network service. The client device may periodically and automatically “sync” with the contact manager network service. Alternatively, the client device may send the request to sync in response to user input. Alternatively still, the client device may use a browser to send an HTTP request to the contact manager network service to retrieve a webpage. The webpage, when rendered by the browser, includes code that, when executed by the browser, causes the phone number to be highlighted, similar to a hyperlink in a typical webpage. Upon user selection of the highlighted phone number, the client device initiates a call to a device identified by the phone number.

Sending the formatted contact data to a client device may comprise inserting code into the contact data that causes a GUI object to be displayed at the client device. The GUI object is associated with a particular phone number and may comprise an icon. User selection of the GUI object causes the client device to initiate a call to a device identified by the particular phone number.

Alternatively, sending the formatted contact data to a client device may comprise sending data that indicates that a phone number in the contact data is a phone number. For example, the formatted contact data may be formatted in a row-column format where each column corresponds to a different type of contact information, such as phone number, name, business address, and email address. A client device (such as client device 108A or 108B) is configured to use this additional data to identify that a phone number in the contact data is in fact a phone number. The client device may then, when displaying the phone number, allow the user to select the phone number with a single input (e.g., a single touch on a touch screen or a single selection of a button). User selection of the phone number displayed by the client device causes the client device to initiate call to a mobile device identified by the phone number.

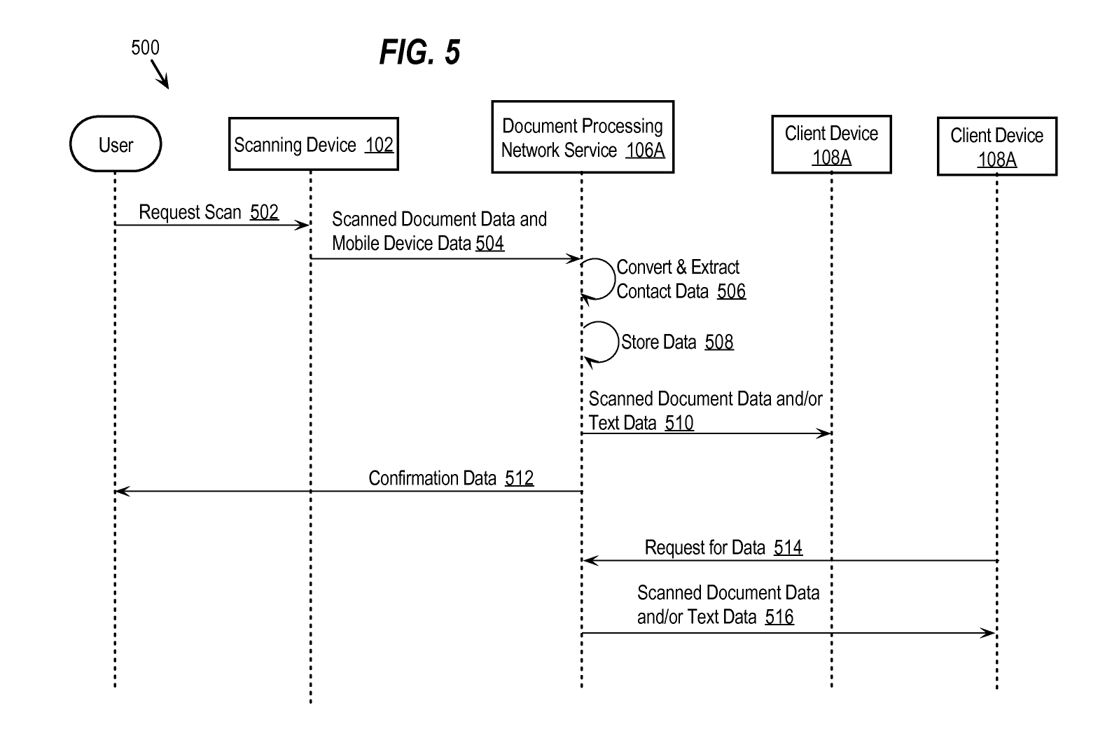

FIG. 5 is a message ladder diagram 500 that depicts an example message exchange between the elements of FIG. 1 during the processing of scanned document data as described herein. In step 502, a user requests that one or more printed documents be scanned. For example, a user may place one or more printed documents into an input bin of scanning device 102 and select the scan-to-mobile GUI object 216. The user also causes contact information (or mobile device data) for an intended recipient of the scanned document data to be sent. For example, the user may specify (or select from a list displayed on GUI 210) a phone number of a mobile device of the intended recipient of the scanned document data. As another example, the one or more printed documents may include contact information of an intended recipient of the scanned document data. In response to the user's request to scan, the scanning device 102 scans the one or more printed documents and generates scanned document data. The scanned document data represents the one or more printed documents and may include mobile device data.

In step 504, the scanning device transmits the scanned document data and the mobile device data to the DPN service 106A. In step 506, DPN service 106A processes the scanned document data and, optionally, generates text data 128 that represents text contained in the one or more printed documents. In step 508, DPN service 106A stores the scanned document data and/or text data 128. In step 510, DPN service 106A uses the mobile device data to transmit the scanned document data (or text data 128) to a mobile device of an intended recipient. For example, DPN service 106A may transmit scanned document data 126 and/or text data 128 to client device 108A using MMS. The scanned document data 126 and/or the text data 128 may be provided to multiple mobile devices identified in the mobile device data, such as client device 108B in addition to 108A.

In step 512, DPN service 106A optionally generates and transmits confirmation data that indicates that the scanned document data 126 and/or text data 128 was provided to the recipient. In the present example, the confirmation data is transmitted to the user that initiated the scan of the one or more printed documents.

In step 514, DPN service 106A may receive a request for scanned document data 126 and/or text data 128 stored in storage 122. In step 516, in response to the request, DPN service 106A provides the requested scanned document data 126 and/or text data 128 to a requestor, for example, client device 108B. For example, DPN service 106 may provide an interface that allows users to retrieve scanned document data 126 and/or the text data 128 stored in storage 122.

The approach described herein for processing scanned contact data provides a beneficial workflow for users. The approach allows a user to scan one or more business cards and cause the scanned contact data to be sent to cloud 104. A network service in cloud 104 extracts contact data (including phone data) from the scanned business card(s). A network service in cloud 104, or outside cloud 104, stores the contact data for later retrieval by the user's device, such as a cell phone. The network service sends one or more identified phone numbers to the user's device. Then, using his/her device, the user can select one of the identified phone numbers that are displayed on the user's device and initiate a call to a mobile device identified by the selected phone number.

### IV. Implementation Mechanisms

Although the flow diagrams of the present application depict a particular set of steps in a particular order, other implementations may use fewer or more steps, in the same or different order, than those depicted in the figures.

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

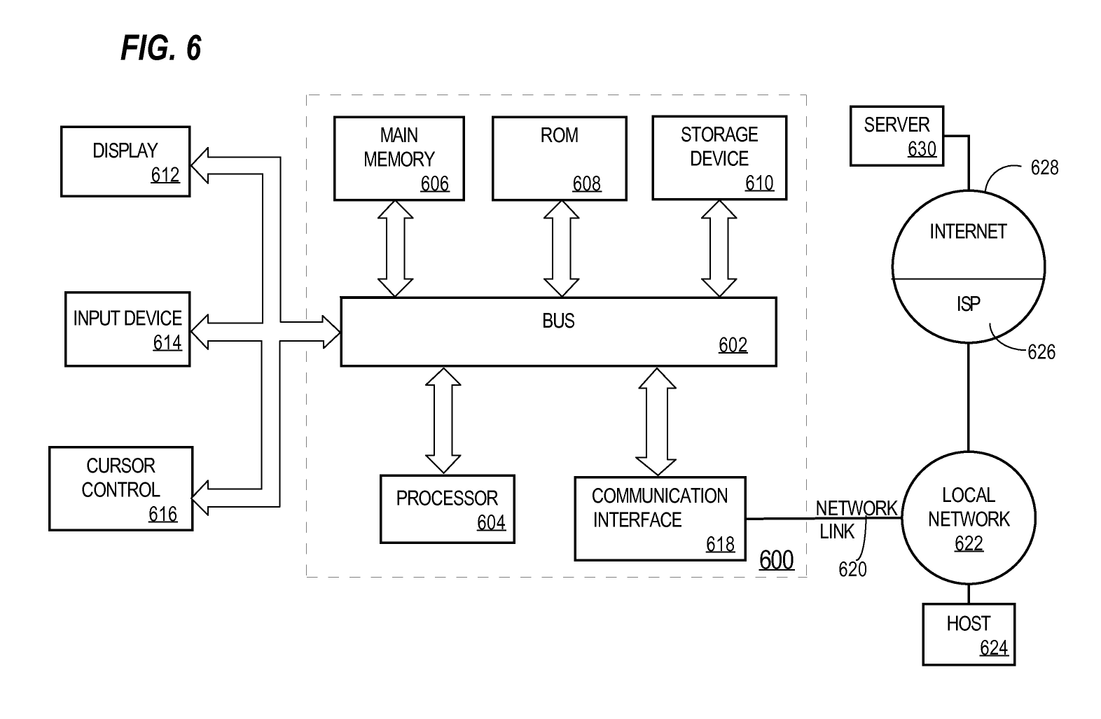

FIG. 6 is a block diagram that depicts an example computer system 600 upon which embodiments of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic or computer software which, in combination with the computer system, causes or programs computer system 600 to be a special-purpose machine. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 600, various computer-readable media are involved, for example, in providing instructions to processor 604 for execution. Such a medium may take many forms, including but not limited to, non-volatile media and volatile media. Non-volatile media includes, for example, optical or magnetic disks, such as storage device 610. Volatile media includes dynamic memory, such as main memory 606. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for processing scanned document data, the computer-implemented method comprising:
a document processing network service executing on a network device and receiving, from a scanning device over a network using an IP protocol, the scanned document data that represents one or more printed documents; and
the document processing network service sending particular document data to a mobile device based on mobile device data received from the scanning device;
wherein the mobile device data includes an identifier of a mobile device of an intended recipient of the scanned document data;
wherein the particular document data is the scanned document data or is document data that is generated from the scanned document data.

2. The computer-implemented method as recited in claim 1, wherein the document processing network service uses Multimedia Messaging Service (MMS) to send the particular document data to the mobile device.

3. The computer-implemented method as recited in claim 1, further comprising the document processing network service receiving, from the scanning device over the network using an IP protocol, the mobile device data, wherein the mobile device data is separate from the scanned document data.

4. The computer-implemented method as recited in claim 3, wherein the mobile device data includes a phone number that was entered by a user of the scanning device.

5. The computer-implemented method as recited in claim 3, further comprising, prior to the document processing network service receiving the scanned document data: receiving, from the scanning device, a request for a list of one or more phone numbers; and
in response to receiving the request, identifying a particular list of one or more phone numbers and sending the particular list to the scanning device.

6. The computer-implemented method as recited in claim 1, wherein:
the scanned document data includes the mobile device data;
the method further comprising:
processing the scanned document data,
generating text data that represents text contained in the one or more printed documents,
analyzing the text data to identify particular mobile device data, and
wherein sending particular document data to a mobile device comprises using the particular mobile device data to send the particular document data to the mobile device.

7. One or more storage media storing instructions for processing scanned document data, wherein the instructions, when processed by one or more processors, cause:
a document processing network service executing on a network device and receiving, from a scanning device over a network using an IP protocol, the scanned document data that represents one or more printed documents; and
the document processing network service sending particular document data to a mobile device based on mobile device data received from the scanning device;
wherein the mobile device data includes an identifier of a mobile device of an intended recipient of the scanned document data;
wherein the particular document data is the scanned document data or is document data that is generated from the scanned document data.

8. The one or more storage media as recited in claim 7, wherein the document processing network service uses Multimedia Messaging Service (MMS) to send the particular document data to the mobile device.

9. The one or more storage media as recited in claim 7, wherein the instructions, when processed by the one or more processors, further causes the document processing network service receiving, from the scanning device over the network using an IP protocol, the mobile device data, wherein the mobile device data is separate from the scanned document data.

10. The one or more storage media as recited in claim 9, wherein the mobile device data includes a phone number that was entered by a user of the scanning device.

11. The one or more storage media as recited in claim 9, wherein the instructions, when processed by the one or more processors, further causes, prior to the document processing network service receiving the scanned document data:
receiving, from the scanning device, a request for a list of one or more phone numbers; and
in response to receiving the request, identifying a particular list of one or more phone numbers and sending the particular list to the scanning device.

12. The one or more storage media as recited in claim 7, wherein:
the scanned document data includes the mobile device data;
the instructions, when processed by one or more processors, further cause:
processing the scanned document data,
generating text data that represents text contained in the one or more printed documents, and
analyzing the text data to identify particular mobile device data, and
wherein sending particular document data to a mobile device comprises using the particular mobile device data to send the particular document data to the mobile device.

13. One or more storage media storing instructions for processing scanned contact data, wherein the instructions, when processed by one or more processors, causes:
a document processing network service executing on a network device and receiving, from a scanning device over a network using an IP protocol, (a) the scanned contact data that represents one or more printed documents that include contact data and (b) recipient data that includes an identifier of an intended recipient of contact data within the scanned contact data;
in response to the document processing network service receiving the scanned contact data:
generating text data that represents text contained in the one or more printed documents,
processing the text data to identify, in the text data, phone data for an intended recipient, and
sending, based on the recipient data, the phone data to a contact manager network service associated with the recipient.

14. The one or more storage media as recited in claim 13, wherein:
the one or more printed documents includes a business card; and
the contact data includes one or more of a name of a person, phone number, an email address, or a business address.

15. The one or more storage media as recited in claim 13, wherein:
the scanned document data is in portable document format, and
generating text data comprises performing optical character recognition on the scanned document data.

16. The one or more storage media as recited in claim 13, wherein the mobile device of the recipient retrieves the phone data from the contact manager network service.

17. The one or more storage media as recited in claim 13, wherein processing the text data to identify in the text data phone data for a recipient includes identifying one or more text strings contained in the text data that match one or more specified text strings.
